(19) United States
(12) Patent Application Publication
(10) Pub. No.: US 2023/0244749 A1
(43) Pub. Date: Aug. 3, 2023

(54) GPU COMMUNICATION METHOD AND DEVICE, AND MEDIUM

(71) Applicant: INSPUR SUZHOU INTELLIGENT TECHNOLOGY CO., LTD., Jiangsu (CN)

(72) Inventor: Jiangang LUO, Jiangsu (CN)

(21) Appl. No.: 18/013,170

(22) PCT Filed: Feb. 24, 2021
(86) PCT No.: PCT/CN2021/077646

§ 371 Date: Dec. 27, 2022

(30) Foreign Application Priority Data
Jun. 29, 2020 (CN) 202010602573.7

(51) Int. Cl. G06F 17/16; G06F 15/163

(52) U.S. Cl. CPC G06F 17/16; G06F 15/163

(57) ABSTRACT

Provided is a GPU communication method, including: decomposing a matrix to be transmitted on each GPU into sub-matrices and a compressed matrix, wherein the compressed matrix obtained by decomposing each matrix to be transmitted is the same; causing each GPU to perform a reduce operation for respective sub-matrices, such that each GPU obtains an intermediate matrix; performing an allgather operation on each GPU, such that each GPU respectively sends the intermediate matrix of the GPU itself to all other GPUs; and respectively multiplying, by the compressed matrix, one or more intermediate matrices received by each GPU and the intermediate matrix of the GPU itself, so as to obtain a final matrix. Also provided are a computer device and a readable storage medium. By means of the solution, the complexity of communication is greatly reduced by decomposing the matrix. On the premise of ensuring the convergence precision, a part of smaller feature values may be deleted, thereby further reducing data transmission.

### CROSS-REFERENCE TO RELATED APPLICATION

The present application claims the priority of Chinese Patent Application 202010602573.7, filed in the State Intellectual Property Office of China on Jun. 29, 2020, and entitled “GPU Communication Method, and Device and Medium”, the entire contents of which are herein incorporated by reference.

### TECHNICAL FIELD

The present disclosure relates to the field of Graphics Processing Units (GPUs), and in particular, to a GPU communication method, and a device and a storage medium.

### BACKGROUND

Large-scale parallel data training of deep learning occupies more and more time, and how to reasonably and efficiently utilize low-speed network transmission is a problem to be solved in the case of a high-speed transmission network and a high hardware cost. The low transmission efficiency of low-speed networks has gradually become the bottleneck of large-scale training of neural networks.

An annular communication algorithm is a common method for GPU communication, and is usually used when the data volume is relatively large. The annular communication algorithm may effectively utilize a pipeline technology, and has good expansibility on multiple GPUs. However, under the limitation of a low-speed bandwidth, for example, when a part of connection is implemented through a Peripheral Component Interconnect Express (PCIE), the transmission speed thereof is only about 7.5 Gb/s, which has gradually become the bottleneck of GPU calculation.

### SUMMARY

In view of the above, in order to overcome at least one aspect of the foregoing problems, an aspect of the embodiments of the present disclosure provides a GPU communication method, including the following operations:

decomposing a matrix to be transmitted on each GPU into sub-matrices and a compressed matrix, wherein the compressed matrix obtained by decomposing each matrix to be transmitted is the same;

causing each GPU to perform a reduce (reduce) operation for respective sub-matrices, such that each GPU obtains an intermediate matrix;

performing an allgather operation on each GPU, such that each GPU respectively sends the intermediate matrix of the GPU itself to all other GPUs; and

respectively multiplying, by the compressed matrix, one or more intermediate matrices received by each GPU and the intermediate matrix of the GPU itself, so as to obtain a final matrix.

In some embodiments, causing each GPU to perform the reduce operation for the respective sub-matrices, such that each GPU obtains the intermediate matrix further includes:

performing a compress operation on the intermediate matrix on each GPU; and

the operation of respectively multiplying, by the compressed matrix, one or more intermediate matrices received by each GPU and the intermediate matrix of the GPU itself, so as to obtain the final matrix further includes:

performing a decompress operation on the one or more intermediate matrices received by each GPU and the intermediate matrix of the GPU itself, and respectively multiplying, by the compressed matrix, the one or more intermediate matrices and the intermediate matrix of the GPU itself, so as to obtain the final matrix.

In some embodiments, the method further includes:

when causing each GPU to perform the decompress operation for a respective first sub-matrix to be transmitted, causing each GPU to start to sequentially perform the reduce operation, the compress operation, the allgather operation and the decompress operation for a respective second sub-matrix to be transmitted.

In some embodiments, the method further includes:

after causing each GPU to perform the compress operation for the respective first sub-matrix to be transmitted, causing each GPU to start to sequentially perform the reduce operation, the compress operation, the allgather operation and the decompress operation for a respective third sub-matrix to be transmitted.

In some embodiments, the method further includes:

when causing each GPU to perform the compress operation for the respective second sub-matrix to be transmitted, causing each GPU to perform the allgather operation for the respective third sub-matrix to be transmitted.

In some embodiments, the method further includes:

when causing each GPU to perform the allgather operation for the respective first sub-matrix to be transmitted, causing each GPU to perform the compress operation for the respective third sub-matrix to be transmitted.

In some embodiments, the method further includes:

when causing each GPU to perform the decompress operation for the respective third sub-matrix to be transmitted, causing each GPU to start to sequentially perform the reduce operation, the compress operation, the allgather operation and the decompress operation for a respective fourth sub-matrix to be transmitted.

In some embodiments, the method further includes:

when causing each GPU to perform the allgather operation for the respective second sub-matrix to be transmitted, causing each GPU to perform the compress operation for the respective fourth sub-matrix to be transmitted.

Based on the same inventive concept, another aspect of the embodiments of the present disclosure provides a computer device, including:

at least one processor; and

a memory, which stores a computer program executable on the processor, wherein when executing the computer program, the processor executes the operations of any GPU communication method as described above.

Based on the same inventive concept, another aspect of the embodiments of the present disclosure provides a computer-readable storage medium, which stores a computer program, wherein when executed by a processor, the computer program executes the operations of any GPU communication method as described above.

The embodiments of the present disclosure have one of the following beneficial technical effects: by means of the solution provided in the embodiments of the present disclosure, the complexity of communication is greatly reduced by decomposing the matrix. On the premise of ensuring the convergence precision, a part of smaller feature values may be deleted, thereby further reducing data transmission.

### BRIEF DESCRIPTION OF THE DRAWINGS

To illustrate technical solutions in the embodiments of the present disclosure or in the related art more clearly, a brief introduction on the drawings which are referred to in the description of the embodiments or the related art is given below. Apparently, the drawings in the description below are merely some of the embodiments of the present disclosure, based on which other drawings may be obtained by those having ordinary skill in the art without any creative effort.

FIG. 1 is a schematic flow diagram of a GPU communication method according to an embodiment of the present disclosure;

FIG. 2 is a schematic diagram of decomposing a matrix according to an embodiment of the present disclosure;

FIG. 3 is a schematic diagram of a result obtained after each GPU decomposes each matrix to be transmitted into a plurality of sub-matrices according to an embodiment of the present disclosure;

FIG. 4 is a schematic diagram of a result obtained after each GPU performs a reduce operation according to an embodiment of the present disclosure;

FIG. 5 is a schematic diagram of a result obtained after each GPU performs a compress operation according to an embodiment of the present disclosure;

FIG. 6 is a schematic diagram of a result obtained after each GPU performs an allgather operation according to an embodiment of the present disclosure;

FIG. 7 is a schematic diagram of a result obtained after each GPU performs a decompress operation according to an embodiment of the present disclosure;

FIG. 8 is a schematic diagram of a pipeline according to an embodiment of the present disclosure;

FIG. 9 is a schematic diagram of another pipeline according to an embodiment of the present disclosure;

FIG. 10 is a schematic structural diagram of a computer device according to an embodiment of the present disclosure; and

FIG. 11 is a schematic structural diagram of a computer-readable storage medium according to an embodiment of the present disclosure.

### DETAILED DESCRIPTION OF THE EMBODIMENTS

In order to make the objectives, technical solutions and advantages of the present disclosure clearer, the embodiments of the present disclosure will be further described in detail below in combination with exemplary embodiments and with reference to the drawings.

It should be noted that, all expressions using “first” and “second” in the embodiments of the present disclosure are to distinguish two different entities or different parameters with the same name. Therefore, “first” and “second” are only for the convenience of expression, and should not be construed as limitations to the embodiments of the present disclosure, which will not be described one by one in subsequent embodiments.

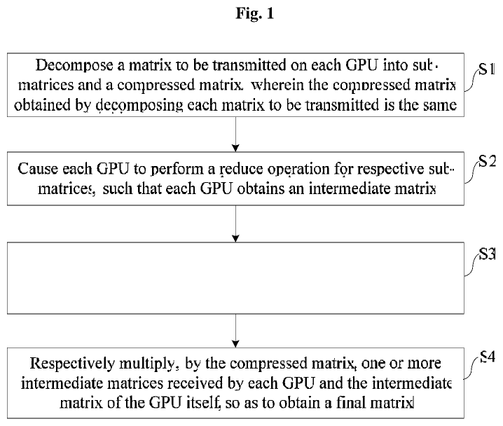

According to one aspect of the present disclosure, an embodiment of the present disclosure provides a GPU communication method. As shown in FIG. 1, the method may include the following operations:

S1, decomposing a matrix to be transmitted on each GPU into sub-matrices and a compressed matrix, wherein the compressed matrix obtained by decomposing each matrix to be transmitted is the same;

S2, causing each GPU to perform a reduce operation for respective sub-matrices, such that each GPU obtains an intermediate matrix;

S3, performing an allgather operation on each GPU, such that each GPU respectively sends the intermediate matrix of the GPU itself to all other GPUs; and

S4, respectively multiplying, by the compressed matrix, one or more intermediate matrices received by each GPU and the intermediate matrix of the GPU itself, so as to obtain a final matrix.

By means of the solution provided in the embodiment of the present disclosure, the complexity of communication is greatly reduced by decomposing the matrix. On the premise of ensuring the convergence precision, a part of smaller feature values may be deleted, thereby further reducing data transmission.

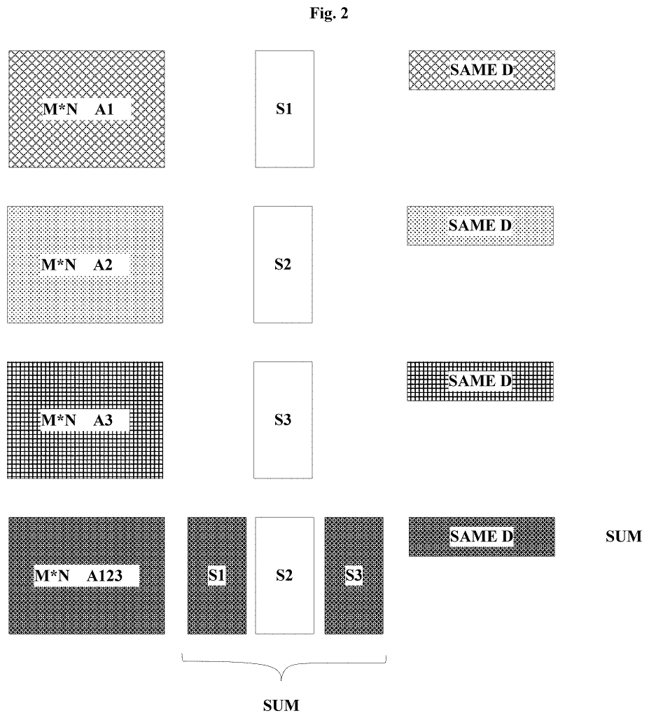

In some embodiments, in the operation S1, the matrix to be transmitted on each GPU is decomposed into sub-matrices and a compressed matrix, wherein the compressed matrix obtained by decomposing each matrix to be transmitted is the same. For example, as shown in FIG. 2, taking matrices A₁, A₂ and A₃ as an example, an intermediate matrix A₁₂₃=A₁+A₂+A₃ may be obtained before compression, as shown on a left side of FIG. 2. According to the matrix decomposition, A₁=S₁*D, A₂=S₂*D and A₃=S₃*D, wherein the matrix S is a sub-matrix, and the matrix D is a compressed matrix, so that it may be obtained that A₁₂₃=(S₁+S₂+S₃)*D. In order to ensure the convenience of addition after decomposition, and to reduce the complexity of matrix operation complexity, it may be particularly set that the D matrices obtained by decomposing the three matrices A₁, A₂ and A₃ are the same. For example, the specific process may be as follows: first, decomposing the matrix A₁, that is, A₁=S₁*D, then substituting the known matrix D into the formula A₂=S₂*D so as to obtain the matrix S₂ by solving a matrix linear equation set, and then obtaining S₃ in the same manner. A certain precision loss may be generated in this process, but is within a controllable error, thereby hardly causing loss to the convergence of a deep learning model.

In this way, by means of decomposition, the matrix A (with a matrix dimension of M*N and a rank of K) may be decomposed into the form of multiplication of a sub-matrix S (with a matrix dimension of M*K) and a compressed matrix D (with a matrix dimension of K*N), or may be decomposed into the form of S*V*D, wherein V represents a diagonal matrix, which is composed of feature values of the matrix. In this case, the complexity of communication may be changed from M*N into M*K+K*N, and when the rank of the matrix is relatively small, the complexity of communication is greatly reduced. On the premise of ensuring the convergence precision, a part of smaller feature values may be deleted, thereby further reducing data transmission.

In some embodiments, the operation S2 of causing each GPU to perform the reduce operation for the respective sub-matrices, such that each GPU obtains the intermediate matrix further includes:

performing a compress operation on the intermediate matrix on each GPU.

The operation S4 of respectively multiplying, by the compressed matrix, one or more intermediate matrices received by each GPU and the intermediate matrix of the GPU itself, so as to obtain the final matrix further includes:

performing a decompress operation on the one or more intermediate matrices received by each GPU and the intermediate matrix of the GPU itself, and respectively multiplying, by the compressed matrix, the one or more intermediate matrices and the intermediate matrix of the GPU itself, so as to obtain the final matrix.

In some embodiments, the reduce operation includes:

decomposing, in each GPU, each matrix to be transmitted into sub-matrices and a compressed matrix, such that each GPU respectively sends a corresponding sub-matrix to all other GPUs, and each GPU adds one or more received sub-matrices with one sub-matrix of the GPU itself, so to obtain the intermediate matrix.

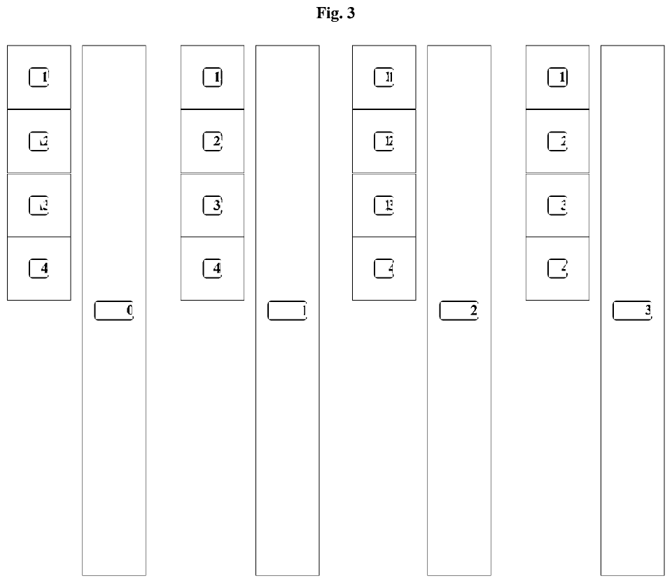

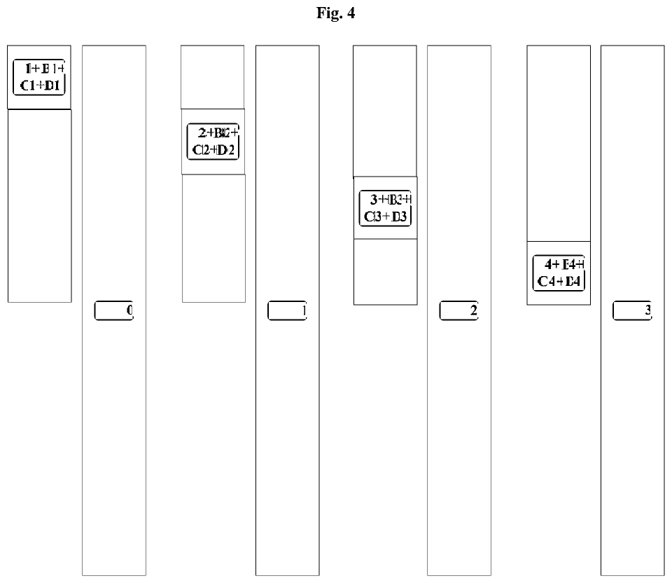

For example, as shown in FIG. 3, taking four GPUs as an example, an ALL_reduce type is selected to be SUM. As shown in FIG. 3, each sub-matrix to be transmitted of each GPU is shown on the left side of each GPU in FIG. 3, and there are four sub-matrices on the left side of each GPU. In this case, after scatter reduce, each GPU obtains a matrix by adding the sub-matrices to be transmitted. For example, as shown in FIG. 4, a GPU0 obtains a sub-matrix B1 of a GPU1, a sub-matrix C1 of a GPU2 and a sub-matrix D1 of a GPU3, and finally, the GPU0 adds a sub-matrix A1 of itself with the obtained sub-matrices B1, C1 and D1, so as to obtain an intermediate matrix.

The GPU1 obtains a sub-matrix A2 of the GPU0, a sub-matrix C2 of the GPU2 and a sub-matrix D2 of the GPU3, and finally, the GPU1 adds a sub-matrix B2 of itself with the obtained sub-matrices A2, C2 and D2, so as to obtain an intermediate matrix.

The GPU2 obtains a sub-matrix A3 of the GPU0, a sub-matrix B3 of the GPU1 and a sub-matrix D3 of the GPU3, and finally, the GPU2 adds a sub-matrix C3 of itself with the obtained sub-matrices A3, B3 and D3, so as to obtain an intermediate matrix.

The GPU3 obtains a sub-matrix A4 of the GPU0, a sub-matrix B4 of the GPU1 and a matrix C4 of the GPU2, and finally, the GPU3 adds a sub-matrix D4 of itself with the obtained sub-matrices A4, B4 and C4, so as to obtain an intermediate matrix.

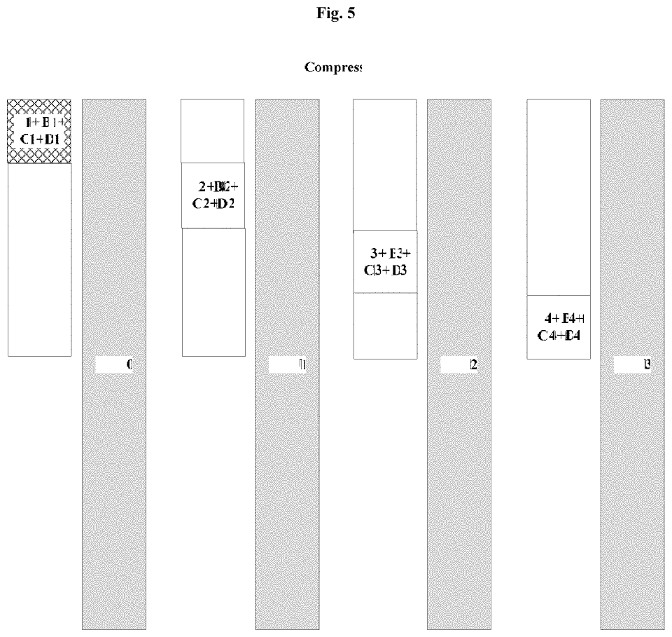

In some embodiments, in the operation S2, a compress operation is performed on the intermediate matrix on each GPU. For example, after obtaining the intermediate matrix, each GPU performs compress processing on the intermediate matrix, as shown in FIG. 5. In FIG. 5, the mesh represents compressed data, that is, the GPU0 compresses the sub-matrix A1 and the obtained sub-matrices B1, C1 and D1, the GPU1 compresses the sub-matrix B2 and the obtained sub-matrices A2, C2 and D2, the GPU0 compresses the sub-matrix C3 and the obtained sub-matrices A3, B3 and D3, and the GPU0 compresses the sub-matrix D4 and the obtained sub-matrices A4, B4 and C4.

In some embodiments, in order to consider the universality of the compression algorithm, the selected compression algorithm is a floating point compression algorithm with a fixed compression ratio, and the compression ratio of fixed compression of the compression algorithm may be adjusted so as to meet the requirements of different precision. The compression algorithm has been implemented by an open source code zfp (an algorithm library for floating point data compression), and the open source library thereof may be used as a compression tool in combination with annular communication, wherein zfp is used as an open source code library to support data compression of floating-point numbers and integers. Moreover, a plurality of forms, such as fixed precision and fixed ratio, are supported, and the data compression of different dimensions such as one-dimensional and two-dimensional is supported. Moreover, various different interfaces such as C++ and Python are provided. In addition, the form of a fixed compression ratio may also be used, and the compression algorithm used in the embodiments of the present disclosure intercepts a CUDA (Compute Unified Device Architecture, which is a GPU-based computing platform proposed by VNIDIA) code implemented therein. A zfp internal compression method is based on orthogonal transformation, and the main loss is generated from low-bit rounding, and since the method is implemented by the open source code, no detailed description will be given herein.

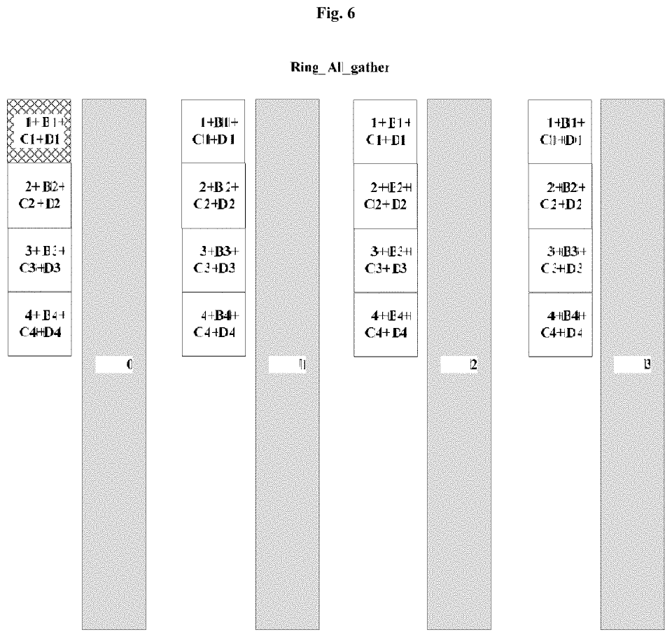

In some embodiments, in the operation S3, an allgather operation is performed on each GPU, such that each GPU respectively sends the intermediate matrix of the GPU itself to all other GPUs. For example, as shown in FIG. 6, after each GPU compresses the corresponding intermediate matrix, allgather transmission is performed on each GPU, such that each GPU obtains all compressed data, that is, GPU0-GPU3 all obtain the intermediate matrix generated by compressing the sub-matrices A1, B1, C1 and D1, the intermediate matrix generated by compressing the sub-matrices A2, B2, C2 and D2, the intermediate matrix generated by compressing the sub-matrices A3, B3, C3 and D3, and the intermediate matrix generated by compressing the sub-matrices A4, B4, C4 and D4.

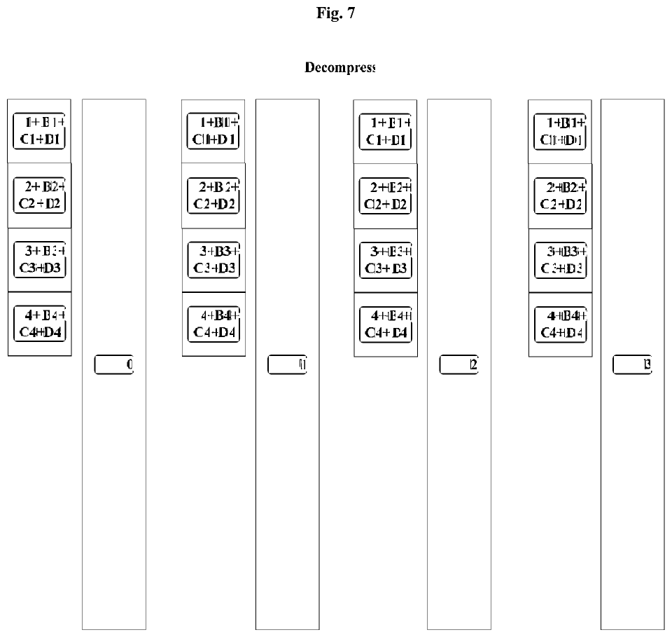

In some embodiments, in the operation S4, after a decompress operation is performed on the one or more intermediate matrices received by each GPU and the intermediate matrix of the GPU itself, the one or more intermediate matrices and the intermediate matrix of the GPU itself are respectively multiplied by the compressed matrix, so as to obtain the final matrix. For example, as shown in FIG. 7, after each GPU obtains all intermediate matrices, each GPU decompresses all intermediate matrices, and then multiplies the decompressed intermediate matrices by the compressed matrix D, so that each GPU obtains data after adding all matrices.

In some embodiments, the method further includes:

when causing each GPU to perform the decompress operation for a respective first sub-matrix to be transmitted, causing each GPU to start to sequentially perform the reduce operation, the compress operation, the allgather operation and the decompress operation for a respective second sub-matrix to be transmitted.

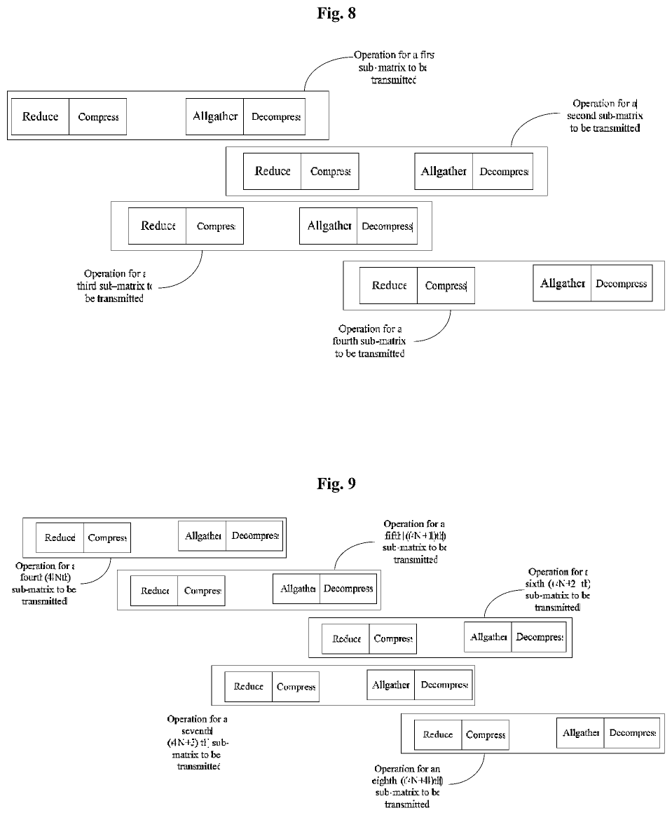

In some exemplary implementation, in order to reduce a calculation time occupied by compression and decompression which influences the program efficiency, dual pipelines are used to hide the compress and decompress time, so as to improve the program efficiency. For example, as shown in FIG. 8, it may be seen that the reduce operation, the compress operation, the allgather operation and the decompress operation are respectively performed for four sub-matrices to be transmitted, wherein the first sub-matrix to be transmitted and the second sub-matrix to be transmitted form a first layer of pipeline (pipeline 1), and the third sub-matrix to be transmitted and the fourth sub-matrix to be transmitted form a second layer of pipeline (pipeline 2). In each layer of pipeline (taking pipeline 1 as an example), firstly, each GPU is started to perform an operation on the first sub-matrix to be transmitted, when each GPU performs the decompress operation for the first sub-matrix to be transmitted, each GPU is caused to start to sequentially perform the reduce operation, the compress operation, the allgather operation and the decompress operation for the second sub-matrix to be transmitted. In this way, the decompress operation for the first sub-matrix to be transmitted and the reduce operation for the second sub-matrix to be transmitted are performed at the same time, thereby hiding the decompress time.

In some embodiments, the method further includes:

after causing each GPU to perform the compress operation for the respective first sub-matrix to be transmitted, causing each GPU to start to sequentially perform the reduce operation, the compress operation, the allgather operation and the decompress operation for a respective third sub-matrix to be transmitted.

For example, the pipeline 2 is started after the compress operation is performed for the first sub-matrix to be transmitted, so that the allgather operation and the compress operation are performed at the same time, so as to hide the compress time. That is, after each GPU is caused to perform the compress operation for the first sub-matrix to be transmitted, each GPU is caused to start to sequentially perform the reduce operation, the compress operation, the allgather operation and the decompress operation for the respective third sub-matrix to be transmitted.

In some embodiments, the method further includes:

when causing each GPU to perform the compress operation for the respective second sub-matrix to be transmitted, causing each GPU to perform the allgather operation for the respective third sub-matrix to be transmitted.

In some embodiments, the method further includes:

when causing each GPU to perform the allgather operation for the respective first sub-matrix to be transmitted, causing each GPU to perform the compress operation for the respective third sub-matrix to be transmitted.

In some embodiments, the method further includes:

when causing each GPU to perform the decompress operation for the respective third sub-matrix to be transmitted, causing each GPU to start to sequentially perform the reduce operation, the compress operation, the allgather operation and the decompress operation for a respective fourth sub-matrix to be transmitted.

For example, in pipeline 2, as shown in FIG. 7, after each GPU is caused to perform the decompress operation for the respective third sub-matrix to be transmitted and multiply the compressed matrix D, each GPU is caused to start to sequentially perform the reduce operation, the compress operation, the allgather operation and the decompress operation for the respective fourth sub-matrix to be transmitted.

In some embodiments, the method further includes:

when causing each GPU to perform the allgather operation for the respective second sub-matrix to be transmitted, causing each GPU to perform the compress operation for the respective fourth sub-matrix to be transmitted.

It should be noted that, since a communication bandwidth occupied by allgather transmission occupies few computing resources, so that the allgather operation and the compress operation are simultaneously performed without generating competition for the computing resources and without affecting each other. Moreover, by means of adjusting the size of the data volume of each ring transmission and changing the compression data volume of each thread of the zfp, the compress time and the decompress time are less than the allgather time and the reduce time, such that the transmission time is not affected, and the pipeline may run efficiently.

In some embodiments, as shown in FIG. 9, since the size of each sub-matrix to be transmitted may be controlled and the size of the sub-matrix is limited, when the number of sub-matrices to be transmitted of each GPU is greater than 4, according to a logic that a fifth sub-matrix to be transmitted is treated as the first sub-matrix to be transmitted, a sixth sub-matrix to be transmitted is treated as the second sub-matrix to be transmitted, a seventh sub-matrix to be transmitted is treated as the third sub-matrix to be transmitted, and an eighth sub-matrix to be transmitted is treated as the fourth to-be-transmitted sub-matrix, the reduce operation, the compress operation, the allgather operation and the decompress operation are performed in sequence. Moreover, after the compress operation is performed on the fourth sub-matrix to be transmitted, the reduce operation of the fifth sub-matrix to be transmitted is performed, and the reduce operation, the compress operation, the allgather operation and the decompress operation are started to be performed in sequence, and so on. That is, according to the logic that a (4N+1)th sub-matrix to be transmitted is treated as the first sub-matrix to be transmitted, a (4N+2)th sub-matrix to be transmitted is treated as the second sub-matrix to be transmitted, a (4N+3)th sub-matrix to be transmitted is treated as the third sub-matrix to be transmitted, and a (4N+4)th sub-matrix to be transmitted is treated as the fourth sub-matrix to be transmitted, the reduce operation, the compress operation, the allgather operation and the decompress operation are performed in sequence. Moreover, after the compress operation is performed on the 4Nth sub-matrix to be transmitted, the reduce operation of the (4N+1)th sub-matrix to be transmitted is performed, and the reduce operation, the compress operation, the allgather operation and the decompress operation are started to be performed in sequence, and so on, wherein N is a positive integer.

In some embodiments, in a case where the number of the sub-matrices does not satisfy 4N, the compress operation and the decompress operation are not performed, and only the reduce operation and the allgather operation are performed.

In general, by means of the operations of dual pipelines, the compress operation is simultaneously performed with the ring_allgather operation, decompress and scatter reduce, thereby hiding the compress and decompress time, effectively reducing the data transmission volume, and improving the transmission bandwidth. Further, the dual pipelines are combined in NCCL (Nvidia Collective multi-GPU Communication Library), thereby greatly improving the convenience of usage.

By means of the solution provided in the embodiments of the present disclosure, the complexity of communication is greatly reduced by decomposing the matrix. On the premise of ensuring the convergence precision, a part of smaller feature values may be deleted, thereby further reducing data transmission.

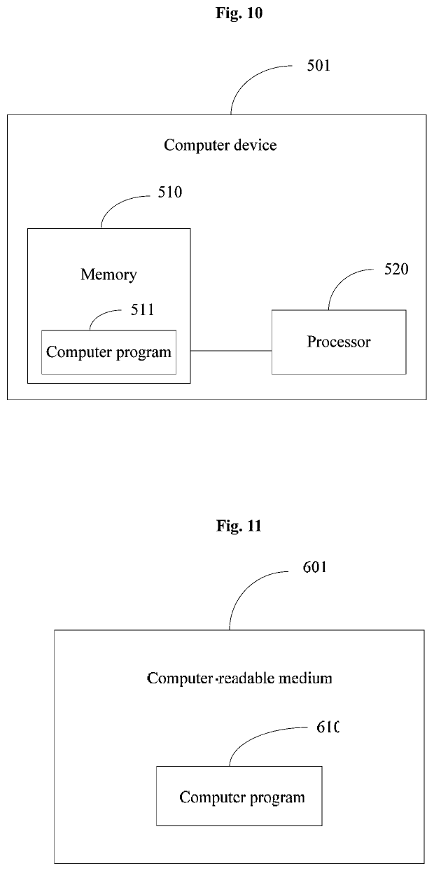

Based on the same inventive concept, according to another aspect of the present disclosure, as shown in FIG. 10, an embodiment of the present disclosure provides a computer device 501, including:

at least one processor 520; and

a memory 510, which stores a computer program 511 executable on the processor, wherein when executing the computer program 511, the processor 520 executes the operations of any GPU communication method as described above.

Based on the same inventive concept, according to another aspect of the present disclosure, as shown in FIG. 11, an embodiment of the present disclosure provides a computer-readable storage medium 601, wherein the computer-readable storage medium 601 stores a computer program 610, and when executed by a processor, the computer program 610 executes the operations of any GPU communication method as described above.

Finally, it should be noted that, those having ordinary skill in the art may understand that all or some of processes in the above embodiments may be implemented by instructing relevant hardware by means of a computer program, the program may be stored in a computer-readable storage medium, and when executed, the program may include the processes of the embodiments of the above methods.

In addition, it should be aware that, the computer-readable storage medium (e.g., a memory) herein may be a volatile memory or a non-volatile memory, or may include both the volatile memory and the non-volatile memory.

It will also be apparent to those having ordinary skill in the art that, various exemplary logical blocks, modules, circuits and algorithm operations described in combination with the disclosure herein may be implemented as electronic hardware, computer software, or a combination of both. To clearly illustrate this interchangeability of hardware and software, the functions of exemplary components, blocks, modules, circuits and operations have been generally described. Whether such functions are implemented as software or hardware depends on particular applications and design constraints imposed on the entire system. Those having ordinary skill in the art may implement the functions in various ways for each specific application, but such implementation decisions should not be construed as departing from the scope disclosed in the embodiments of the present disclosure.

The above descriptions are exemplary embodiments disclosed in the present disclosure, but it should be noted that, various changes and modifications may be made without departing from the scope disclosed in the embodiments of the present disclosure as defined in the claims. The functions, operations and/or actions of the method claims according to the disclosed embodiments described herein need not be performed in any particular order. In addition, although the elements disclosed in the embodiments of the present disclosure may be described or claimed in individual forms, unless explicitly limited to be singular, they may also be understood as a plurality of.

It should be understood that, as used herein, a singular form “a” is intended to include a plural form as well, unless the context clearly supports exceptions. It should also be understood that, “and/or” as used herein refers to any and all possible combinations, including one or more items listed in association.

The sequence numbers of the embodiments disclosed in the embodiments of the present disclosure are merely for description, and do not represent the advantages and disadvantages of the embodiments.

Those having ordinary skill in the art may understand that, all or part of operations for implementing the above embodiments may be completed by hardware, or may be completed by instructing relevant hardware through a program, the program may be stored in a computer-readable storage medium, and the storage medium mentioned above may be a read-only memory, a magnetic disk or an optical disk.

It should be understood by those having ordinary skill in the art to which the present disclosure belongs that, the discussion for any above embodiments is merely illustrative and is not intended to imply that the scope (including the claims) disclosed in the embodiments of the present disclosure is limited to these examples; under the idea of the embodiments of the present disclosure, the technical features in the above embodiments or different embodiments may also be combined with each other, and there are many other changes in the different aspects of the embodiments of the present disclosure as described above, which are not provided in detail for the sake of brevity. Therefore, any omissions, modifications, equivalent replacements, improvements and the like, made within the spirit and principles of the embodiments of the present disclosure, shall be included in the protection scope of the embodiments of the present disclosure.

1. A Graphics Processing Unit (GPU) communication method, comprising:
decomposing a matrix to be transmitted on each GPU into sub-matrices and a compressed matrix, wherein the compressed matrix obtained by decomposing each matrix to be transmitted is the same;
causing each GPU to perform a reduce operation for respective sub-matrices, such that each GPU obtains an intermediate matrix;
performing an allgather operation on each GPU, such that each GPU respectively sends the intermediate matrix of the GPU itself to all other GPUs; and
respectively multiplying, by the compressed matrix, one or more intermediate matrices received by each GPU and the intermediate matrix of the GPU itself, so as to obtain a final matrix.

2. The method according to claim 1, wherein causing each GPU to perform the reduce operation for the respective sub-matrices, such that each GPU obtains the intermediate matrix further comprises:
performing a compress operation on the intermediate matrix on each GPU; and
respectively multiplying, by the compressed matrix, one or more intermediate matrices received by each GPU and the intermediate matrix of the GPU itself, so as to obtain the final matrix further comprises:
performing a decompress operation on the one or more intermediate matrices received by each GPU and the intermediate matrix of the GPU itself, and respectively multiplying, by the compressed matrix, the one or more intermediate matrices and the intermediate matrix of the GPU itself, so as to obtain the final matrix.

3. The method according to claim 2, further comprising:
when causing each GPU to perform the decompress operation for a respective first sub-matrix to be transmitted, causing each GPU to start to sequentially perform the reduce operation, the compress operation, the allgather operation and the decompress operation for a respective second sub-matrix to be transmitted.

4. The method according to claim 3, further comprising:
after causing each GPU to perform the compress operation for the respective first sub-matrix to be transmitted, causing each GPU to start to sequentially perform the reduce operation, the compress operation, the allgather operation and the decompress operation for a respective third sub-matrix to be transmitted.

5. The method according to claim 4, further comprising:
when causing each GPU to perform the compress operation for the respective second sub-matrix to be transmitted, causing each GPU to perform the allgather operation for the respective third sub-matrix to be transmitted.

6. The method according to claim 4, further comprising:
when causing each GPU to perform the allgather operation for the respective first sub-matrix to be transmitted, causing each GPU to perform the compress operation for the respective third sub-matrix to be transmitted.

7. The method according to claim 4, further comprising:
when causing each GPU to perform the decompress operation for the respective third sub-matrix to be transmitted, causing each GPU to start to sequentially perform the reduce operation, the compress operation, the allgather operation and the decompress operation for a respective fourth sub-matrix to be transmitted.

8. The method according to claim 7, further comprising:
when causing each GPU to perform the allgather operation for the respective second sub-matrix to be transmitted, causing each GPU to perform the compress operation for the respective fourth sub-matrix to be transmitted.

9. A computer device, comprising:
at least one processor; and
a memory, which stores a computer program executable on the processor, wherein when executing the computer program, the processor executes the operations of the method according to claim 1.

10. A non-transitory computer-readable storage medium, which stores a computer program, wherein when executed by a processor, the computer program executes the operations of the method according to claim 1.

11. The method according to claim 1, wherein causing each GPU to perform the reduce operation for respective sub-matrices, such that each GPU obtains the intermediate matrix comprises:
after decomposing, in each GPU, each matrix to be transmitted into sub-matrices and the compressed matrix, respectively sending, by each GPU, a corresponding sub-matrix to all other GPUs, so that each GPU adds one or more received sub-matrices with one sub-matrix of the GPU itself to obtain the intermediate matrix.

12. The method according to claim 2, wherein performing the compress operation on the intermediate matrix on each GPU comprises:
performing the compress operation on the intermediate matrix on each GPU by using a compression algorithm, wherein the compression algorithm is a floating point compression algorithm with a fixed compression ratio.

13. The method according to claim 12, wherein the compression algorithm is implemented by an open source code zfp.

14. The method according to claim 7, wherein in a case where the number of sub-matrices to be transmitted of each GPU is greater than 4,
a (4N+1)th sub-matrix to be transmitted is treated as the first sub-matrix to be transmitted, a (4N+2)th sub-matrix to be transmitted is treated as the second sub-matrix to be transmitted, a (4N+3)th sub-matrix to be transmitted is treated as the third sub-matrix to be transmitted, and a (4N+4)th sub-matrix to be transmitted is treated as the fourth sub-matrix to be transmitted, wherein N is a positive integer.

15. The method according to claim 14, wherein after the compress operation is performed on the 4Nth sub-matrix to be transmitted, the reduce operation of the (4N+1)th sub-matrix to be transmitted is performed, and the reduce operation, the compress operation, the allgather operation and the decompress operation are started to be performed in sequence.

16. The method according to claim 8 wherein in a case where the number of sub-matrices to be transmitted of each GPU is greater than 4,
a (4N+1)th sub-matrix to be transmitted is treated as the first sub-matrix to be transmitted, a (4N+2)th sub-matrix to be transmitted is treated as the second sub-matrix to be transmitted, a (4N+3)th sub-matrix to be transmitted is treated as the third sub-matrix to be transmitted, and a (4N+4)th sub-matrix to be transmitted is treated as the fourth sub-matrix to be transmitted, wherein N is a positive integer.

17. The method according to claim 16, wherein after the compress operation is performed on the 4Nth sub-matrix to be transmitted, the reduce operation of the (4N+1)th sub-matrix to be transmitted is performed, and the reduce operation, the compress operation, the allgather operation and the decompress operation are started to be performed in sequence.

18. The method according to claim 14, wherein in a case where the number of the sub-matrices does not satisfy 4N, only the reduce operation and the allgather operation are performed without performing the compress operation and the decompress operation.

19. The method according to claim 16, wherein in a case where the number of the sub-matrices does not satisfy 4N, only the reduce operation and the allgather operation are performed without performing the compress operation and the decompress operation.

20. The method according to claim 2, wherein dual pipelines are used to hide compress and decompress time required for performing the compress operation and the decompress operation.
